(19) United States
(12) Patent Application Publication
(10) Pub. No.: US 2014/0354118 A1
(43) Pub. Date: Dec. 4, 2014

(54) ENCODER FOR A COMPACT REVOLUTION TRANSMITTER AND ELECTRIC MOTOR WITH A COMPACT REVOLUTION TRANSMITTER

(71) Applicant: MAXON MOTOR AG, Sachseln (CH)

(72) Inventors: Volker SCHWARZ, Sachseln (CH); Andreas PHILIPP, Sachseln (CH)

(21) Appl. No.: 14/286,693

(22) Filed: May 23, 2014

(30) Foreign Application Priority Data
May 28, 2013 (EP) 13002767.5

(51) Int. Cl. G01D 5/12; H02K 11/00; G01B 7/30

(52) U.S. Cl. CPC G01D 5/12; G01B 7/30; H02K 11/0021
USPC 310/68 B; 324/207.2

(57) ABSTRACT

An encoder is provided for a revolution transmitter, in particular for an electric motor, for sampling a rotationally symmetrical material measure. The encoder comprises at least one integrated sensor circuit, where the integrated sensor circuit is designed in a flexible manner and applied to a likewise flexible circuit board, and where the integrated sensor circuit and the circuit board form a flexible sensor unit and the sensor unit is curved outwardly from a plane. A revolution transmitter with an encoder, as well as an electric motor with such a revolution transmitter, are also provided.

### CROSS-REFERENCE TO RELATED APPLICATION

This application claims priority to foreign European Patent Application EP 13002767.5, filed on May 28, 2013, the disclosure of which is incorporated herein by reference in its entirety.

### FIELD OF THE INVENTION

The present invention relates to an encoder for a revolution transmitter, in particular for an electric motor, for sampling a rotationally symmetrical material measure. The encoder is adapted such that it is suitable for sampling a rotationally symmetric material measure.

### BACKGROUND

Revolution transmitters are well known from prior art. They are used for detecting a rotational angle and are mainly used in electric motors. Not only can the rotational position of the runner be determined with the revolution transmitter, but also its rotational speed. Revolution transmitters are manufactured having various designs and can be based on various physical principles. The possibilities range from purely mechanical sampling through optical detection methods all the way to sensor systems based on Hall-effect sensors.

The general principle of a revolution transmitter is based on a substantially rotationally symmetrical material measure being sampled by a suitable sensor. The sensor is part of an encoder which outputs the position or rotational speed of the rotating material measure in the form of an output signal. Revolution transmitters can be equipped with encoders that are arranged at the outer circumference of the material measure. An example of this would be an incremental revolution transmitter with magnetic sampling. With this revolution transmitter, the material measure is made of a hard magnetic carrier into which recurrent periodic gratings are inscribed by magnetization. Such a material measure is referred to as a magnet wheel with a radial field effect. The sensors positioned at the outer circumference of the magnet wheel can be a Hall-effect element or a magneto-resistive sensor. Both alternatives allow a non-contact read-out of the periodically recurring magnetization of the magnet wheel. However, the revolution transmitter can also be designed such that the sensor is arranged not at the outer circumference but—from an axial perspective—in front of or behind the material measure. In particular revolution transmitters based on optical sampling typically have this second possible design. Both solutions have certain advantages and disadvantages. Regarding the space requirement, revolution transmitters with a sensor positioned at the outer circumference of the material measure are relatively short. The space needed in the radial direction is essentially determined by the size of the sensor. Even with the use of a relatively flat conventionally cased sensor, such as a Hall-effect sensor, the problem arises in particular for revolution transmitters with a small diameter that the sensor casing is due to its required minimum dimensions so to speak projecting tangentially from the outer circumference of the material measure and thereby contributes to relatively large overall dimensions of the revolution transmitter.

Many electric motors have the revolution transmitter integrated into the casing of the electric motor. Especially for small electric motors and miniature electric motors, installation of a revolution transmitter can cause the motor casing needing to be chosen overall somewhat larger than desired.

An electric motor with a disc-shaped revolution transmitter and a sensor positioned at the outer circumference of the disk is known for example from EP 2584678 A2.

The object of the present invention is to provide an encoder for a revolution transmitter which allows for a compact design of the revolution transmitter.

### SUMMARY OF THE INVENTION

The object is satisfied by the features of independent claim 1. According thereto, an encoder of the type mentioned above satisfies the object of the invention when the encoder comprises at least one integrated sensor circuit, where the integrated sensor circuit is designed in a flexible manner and applied to a likewise flexible circuit board, and where the integrated sensor circuit and the circuit board form a flexible sensor unit and the sensor unit is curved outwardly from a plane.

The sensor circuit can be all kinds of thin, flexible integrated semiconductor circuits, and in particular silicon-based. A method for the production of flexible integrated circuits is known, for example, from DE 102006044525 B3. Preferably, the sensor circuit already comprises the signal processing circuit which provides the position or speed data as the output signal. However, the signal processing circuit can also be provided separately, namely either as well likewise in flexible form on the flexible circuit board, or externally, or on or in a further component of the encoder or the revolution transmitter, respectively.

Within the present application, the term “flexible circuit board” is to be understood as being in particular a flexible circuit film. The flexible circuit board is used to connect the integrated sensor circuit, for example, to a suitable evaluation unit or to the electronics of an electric motor.

It can due to the curved shape of the sensor unit be prevented that the encoder takes up unnecessary installation space, which leads to a highly compact design of the revolution transmitter. If the sensor unit is arranged, for example, at the outer circumference of a material measure, then the sensor unit can be curved such that it bears snugly against the surface of the material measure. Compared to conventionally cased sensor chips projecting tangentially from the outer circumference of the material measure, the present invention enables providing a revolution transmitter whose diameter is only slightly larger than the diameter of its material measure. Of course, a certain minimum distance must be maintained between the material measure and the sensor unit to prevent the two components form contacting. The sensor unit can be curved such that the integrated sensor circuit has along its entire length a uniform distance from the material measure—as seen in the circumferential direction of the material measure. For a given maximum tolerance distance, the usable number of gratings of the material measure thereby increases. To the extent that the material measure is a magnet wheel with a radial field effect, also field distortions are compensated by the design of the sensor unit according to the invention, since the sensor circuit is over its entire length aligned quasi perpendicular to the radial field effect.

Advantageous embodiments of the present invention are the subject matter of the dependent claims.

In a particularly preferred embodiment of the present invention, the sensor unit is curved such that it bears snugly against the surface of a rotational body. Since the material measure of a revolution transmitter is basically a rotationally symmetrical body, the advantages mentioned above can thereby already be achieved.

Revolution transmitters are usually equipped with cylindrical or hollow cylindrical material measures, respectively. It is therefore of advantage if the sensor unit bears snugly against the surface of a cylinder. In this, the sensor unit usually covers only a sector of a cylinder surface. It is also conceivable, however, that the sensor unit or at least the flexible circuit board of the sensor unit forms a full or nearly full hollow cylindrical ring.

A closed or nearly closed ring ensures high inherent stability of the sensor unit, whereby the distance to the material measure of the revolution transmitter can be kept extremely small.

In a further preferred embodiment of the present invention, the sensor unit bears snugly against a rotation surface whose diameter is less than 35 mm. This rotation surface is preferably a cylindrical surface. The advantages described above become more noticeable the smaller the diameter of the material measure. Revolution transmitters with an encoder according to the invention are therefore preferably suited for installation in small electric motors or miniature motors with a diameter of less than 35 mm.

In a further particularly preferred embodiment of the present invention, the sensor circuit is a highly integrated flexible chip on a Hall-effect sensor basis. In this embodiment, the revolution transmitter is preferably equipped with a magnet wheel. Highly integrated chips on a Hall-effect sensor basis ensure high precision sampling and can additionally also be designed in an extremely compact manner. Capacitive, inductive, magneto-resistive or optical sensor technologies are also possible. It is also conceivable to realize the sensor chip with organic materials, such as polymers. The microelectronic components and conductor tracks of such a sensor chip could be manufactured from conductive organic molecules, so-called organic semiconductors. Such sensor chips made of organic materials could preferably be based on the principle of optical sampling.

In a further particularly preferred embodiment of the present invention, the encoder further comprises a rigid carrier to which the sensor unit is attached in a curved manner. The carrier ensures that the sensor unit retains its curved shape and additionally allows precise positioning of the sensor unit with respect to the material measure of the revolution transmitter to be sampled. The carrier therefore ensures that the required minimum distance to the material measure is precisely maintained. Preferably, the rigid carrier comprises electrical contact points for connecting the sensor unit, where said electrical contact points of the sensor unit are conductively connected to the contact points of the rigid carrier. The contact points of the sensor unit can be simple end portions of conductor tracks of the flexible circuit board. The rigid carrier can be implemented cost-effectively as a conventional rigid printed circuit board. High precision and stability, however, is offered by a carrier made of ceramic. Carriers made of a metal wire mesh or so-called 3D-MID (Molded Interconnect Devices) plastic carriers with integrated conductor tracks are conceivable.

To connect the electrical contact points of the sensor unit with the electrical contact points of the rigid carrier, they can be either conventionally soldered or welded to each other. Since the sensor unit of the encoders according to the invention is a relatively sensitive component, it is alternatively suggested to glue the contact points to each other using electrically conductive adhesive. The rigid carrier is preferably provided with a connection cable or at least with electrical connections in order to be able to connect the encoder according to the invention to a respective evaluation unit or to the electronics of an electric motor. In this, the contact points of the rigid carrier are, preferably via conductor tracks, conductively connected to the connection cable or the electrical connections.

More preferably, the rigid carrier is designed in a ring-shaped manner. A ring-shaped carrier is particularly easy to manufacture. Also precise positioning of the sensor unit relative to the material measure of the revolution transmitter or relative to the rotor axis of an electric motor, respectively, is facilitated substantially with a ring-shaped carrier. Most preferably, the sensor unit is respectively attached at the outer circumference of the ring-shaped carrier. For example, the sensor unit can at the outer circumference of the carrier be glued to the same. The ring shape of the rigid carrier ensures that the sensor unit is during the attachment procedure automatically bent to the correct shape. The outer circumference of the rigid carrier is preferably slightly larger than the outer circumference of the material measure of the revolution transmitter to be sampled. This ensures that the required minimum distance between the sensor unit and the material measure is maintained. It is of course also possible to embody the rigid carrier only as a segment of a completely closed ring. The ring shape certainly has the advantage that also the revolution transmitter, in which the encoder according to the invention is used, can be formed in a ring-shaped manner. The revolution transmitter can thereby also be installed, for example, in electric motors with an end-to-end shaft. It is pointed out that the carrier can alternatively be formed, for example, as a circular disc. The sensor unit can be attached in a simple manner also at the outer circumference of a disc-shaped carrier.

In a further preferred embodiment, the circuit board comprises a connection section which is led from the encoder to the exterior and adapted to connect the encoder to a respective evaluation unit or the electronics of an electric motor. In this embodiment, the circuit board itself serves as a connector. The carrier can there be omitted. The encoder is thereby even more compact. This is particularly advantageous where the encoder is to be installed into a very small electric motor which can not accommodate an additional carrier. The curved circuit board is preferably designed having a T-shape, where the cross bar of the T together with the integrated sensor circuit forms the flexible sensor unit. The leg of the T on the other hand represents the connector. Preferably, the winding connections of the electric motor are connected to the flexible circuit board so that the circuit board comprises all the necessary connections for the electric motor. This can allow for an otherwise necessary additional circuit board to be omitted.

In a further preferred embodiment of the present invention, the encoder further comprises a casing that surrounds the sensor unit and optionally the carrier, at least in part. Such a casing ensures high stability of the encoder and precise positioning of the sensor unit. In addition, the casing facilitates mounting the encoder, for example, in the casing of an electric motor in which the revolution transmitter is to be used. It is possible that the sensor unit protrudes slightly from the casing, so that sampling of the material measure is ensured, for example, when using an optical sensor. It is also possible at least when sampling a magnet wheel that the sensor unit is completely surrounded by the casing. This additionally increases the robustness of the encoder. The casing can be realized in a cost-effective and simple manner in that the sensor unit and possibly the carrier are spray-coated with or cast in plastic.

In a further particularly preferred embodiment of the present invention, the thickness of the sensor unit is less than 0.25 mm, preferably less than 0.1 mm. This allows the sensor unit to be bent in a simple manner into the desired shape and attached in the desired form to the carrier. In addition, this embodiment provides a particularly compact design of the revolution transmitter.

The present invention also provides a revolution transmitter with an encoder according to the invention. The revolution transmitter comprises the encoder and a rotationally symmetrical material measure to be sampled by the sensor unit of the encoder. Preferably, the sensor unit is curved and held relative to the material measure such that the sensor circuit has a uniform distance from the material measure. The uniform distance is preferably in the range between 0.2 mm and 0.5 mm. At a distance in the range mentioned, a certain safety factor is taken into consideration to prevent the two components from contacting during operation. At the same time, a compact design is still obtained.

The invention further provides an electric motor with a revolution transmitter which includes an encoder according to the invention. The material measure of the revolution transmitter preferable is not the rotor or stator magnets of the electric motor, but an additionally provided material measure, for example, in the form of a magnet wheel with particularly fine gratings in order to be able to particularly precisely detect the angular position or rotational speed of the rotor, respectively. Typical realizable magnetic grating periods are located between 0.5 mm and 5 mm.

### BRIEF DESCRIPTION OF THE DRAWINGS

The invention is further illustrated in more detail using the drawings.

FIG. 1: shows a perspective view of a revolution transmitter according to the invention,

FIG. 2: shows the revolution transmitter according to the invention of FIG. 1 in a front view,

FIG. 3: shows a detailed view of the revolution transmitter according to the invention from FIG. 2,

FIG. 4: shows a longitudinal section of the revolution transmitter according to the invention from FIGS. 1 to 3 along the section line IV drawn in FIG. 2, and

FIG. 5: shows a perspective view of the carrier of the revolution transmitter according to the invention from FIGS. 1 to 4 with a sensor unit to be attached thereto.

It applies to the following embodiments that like parts are designated by like reference numerals. If a drawing contains reference numerals which are not marked in the accompanying figure description, then reference is made to preceding or subsequent figure descriptions.

### DETAILED DESCRIPTION

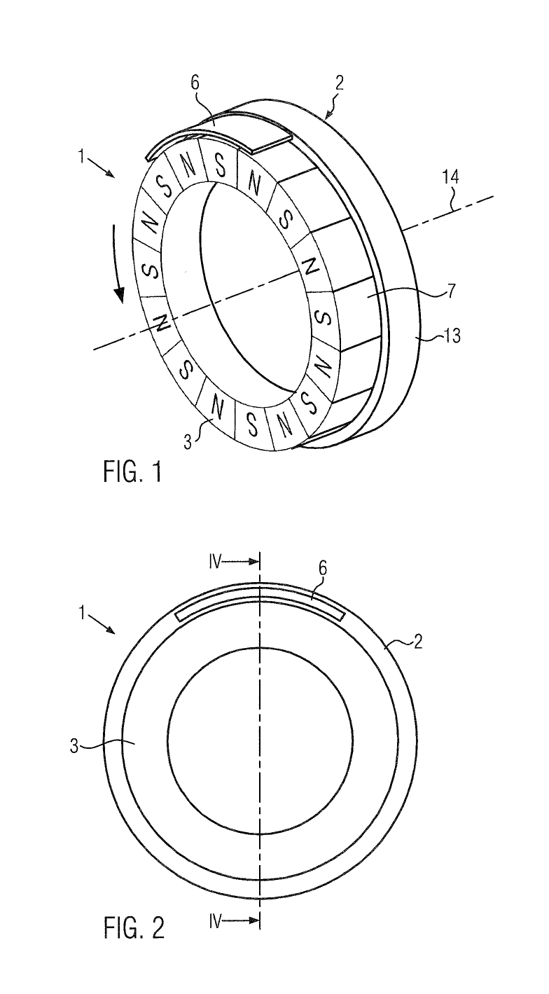

FIG. 1 shows an embodiment of a revolution transmitter 1 according to the invention in an oblique view. The revolution transmitter comprises a rotatably mounted material measure 3 in the form of a magnet wheel and an encoder 2 for sampling the material measure. The support of the material measure is not shown. It can be provided that the material measure does not have its own support, but is connected, for example, fixedly to the rotatably mounted rotor of an electric motor. The magnet wheel is designed substantially as a hollow-cylindrical or ring-shaped component and comprises a magnetic grating indicated in FIG. 1.

The encoder 2 of the revolution transmitter according to the invention also comprises a ring- shaped casing 13 which is disposed coaxially to the material measure. The common axis 14 corresponds to the axis of rotation of the material measure 3. The encoder 2, in contrast to the material measure, is supported stationarily, for example, in the casing of an electric motor. The sensor unit 6 projects from the casing 13 of the encoder 2. The sensor unit 6 is supported by the casing 13 such that it is located directly at the outer circumference 7 of the rotatable material measure 3.

It is shown in FIG. 2 that the sensor unit 6 has a curved shape. It quasi bears snugly against the cylindrical outer circumference 7 of the hollow-cylindrical material measure 3. However, a small air gap of about 0.2 mm remains between the sensor unit 6 and the material measure. This ensures that the material measure can freely rotate relative to the sensor unit 6 of the encoder.

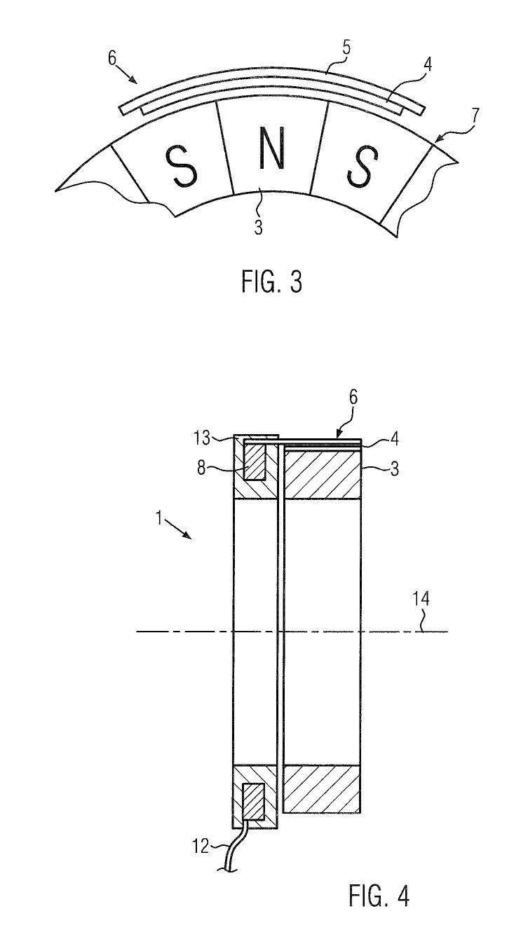

As the detailed view of FIG. 3 shows, the sensor unit is composed of a flexible circuit board 5 and a sensor circuit 4 applied thereto. The sensor circuit 4 is also designed in a flexible manner and is based on the Hall-effect sensor principle. Highly integrated chips on a Hall-effect sensor basis can be designed extremely compact and ensure highly reliable and accurate sampling of the magnet wheel. It is also evident from FIG. 3 that the sensor circuit 4 has a uniform distance across its entire length from the outer circumference of the material measure. The distance corresponds to the air gap of about 0.2 mm already described above.

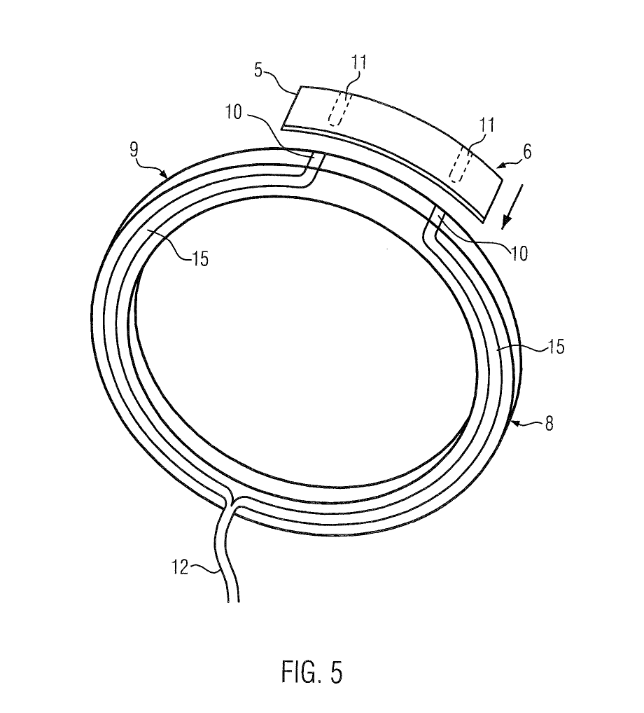

The circuit board 5 of the sensor unit 6 performs two functions. Firstly, it serves the electrical connection of the sensor circuit 4, and, secondly, it also assumes the function of mechanically supporting the sensor circuit. For this purpose, it is attached to a rigid carrier 8, as shown in FIG. 4. The rigid carrier 8 is a ring-shaped rigid circuit board. As can be seen in FIG. 5, the flexible circuit board 5 of the sensor unit 6 is positioned on the cylindrical outer circumference 9 of the rigid carrier 8. The circuit board is then attached to the carrier in a suitable manner. For example, it can be adhesively bonded to the carrier. During the attachment process, the sensor unit is automatically brought into the desired curved shape. The sensor unit is positioned onto the rigid carrier such that the electric contacts 11 shown in FIG. 5 of the sensor unit 6 contact the electric contact points 10 of the rigid carrier 8. The contact points are either welded or soldered to each other or bonded to each other using electrically conductive adhesive.

The carrier 8 comprises conductor tracks 15 via which the contact points 10 are connected to a connection cable 12 of the encoder. The encoder can be connected via the connection cable to the electronics of an electric motor or to a respective evaluation unit.

The casing 13 shown in FIGS. 1, 2 and 4, of the encoder 2 can be easily manufactured by injection-molding. The carrier 8 and the sensor unit 6 are for this spray-coated with or cast in plastic.

It is to be pointed out that the encoder or the revolution transmitter casing, respectively, can represent the rotatably mounted part of the revolution transmitter according to the invention. In this case, the material measure is stationarily supported.

1. An encoder for a revolution transmitter, in particular for an electric motor, for sampling a rotationally symmetrical material measure, comprising:
at least one integrated sensor circuit, wherein said integrated sensor circuit is designed in a flexible manner and applied to a likewise flexible circuit board, and wherein said integrated sensor circuit and said circuit board form a flexible sensor unit, and said sensor unit is curved outwardly from a plane.

2. The encoder according to claim 1, wherein said sensor unit is curved such that it bears snugly against the surface of a rotational body.

3. The encoder according to claim 2, wherein said sensor unit bears snugly against a rotation surface, preferably against a cylinder surface whose diameter is less than 35 mm.

4. The encoder according to claim 1, wherein said sensor circuit is a highly integrated flexible chip on a Hall-effect sensor basis.

5. The encoder according to claim 1, wherein said encoder further comprises a rigid carrier to which said sensor unit is attached in a curved manner.

6. The encoder according to claim 5, wherein said rigid carrier is designed in a ring-shaped manner, where said sensor unit is attached at the outer circumference of said ring-shaped carrier.

7. The encoder according to claim 5, wherein said rigid carrier comprises electrical contact points for connecting said sensor unit, where electrical contact points of said sensor unit are conductively connected to said contact points of said rigid carrier.

8. The encoder according to claim 1, wherein said circuit board comprises a connection section which is led from said encoder to the exterior and adapted to connect said encoder to a respective evaluation unit or to the electronics of an electric motor.

9. The encoder according to claim 1, wherein said encoder further comprises a casing that surrounds said sensor unit and optionally said carrier, at least in part.

10. The encoder according to claim 1, wherein the thickness of said sensor unit is less than 0.25 mm, preferably less than 0.1 mm.

11. A revolution transmitter with an encoder according to claim 1, comprising a rotationally symmetrical material measure to be sampled by said sensor unit of said encoder, where said sensor unit is curved and held relative to said material measure such that said sensor circuit has a uniform distance from said material measure.

12. The revolution transmitter according to claim 11, wherein said uniform distance is in a range between 0.2 mm and 0.5 mm.

13. An electric motor with a revolution transmitter according to claim 12.

14. An electric motor with a revolution transmitter according to claim 11.
